(19) United States
(12) Patent Application Publication
(10) Pub. No.: US 2026/0094035 A1
(43) Pub. Date: Apr. 2, 2026

(54) DATA GENERATION AND CLASSIFICATION BASED ON QUANTUM KERNELS

(71) Applicant: International Business Machines Corporation, Armonk, NY (US)

(72) Inventors: Shungo Miyabe, Tokyo (JP); Noriaki Shimada, Kawasaki-City (JP); Sudeep Ghosh, Bengaluru (IN); Jae-Eun Park, Wappingers Falls, NY (US); Abhijit Mitra, The Woodlands, TX (US)

(21) Appl. No.: 18/903,716

(22) Filed: Oct. 1, 2024

(51) Int. Cl. G06N 10/20; G06N 10/60

(52) U.S. Cl. CPC G06N 10/20; G06N 10/60

(57) ABSTRACT

One or more systems, devices, computer program products and/or computer-implemented methods of use provided herein relate to data classification based on quantum kernels. For example, a system can comprise a memory that can store computer executable components. The system can further comprise a processor that can execute the computer executable components stored in the memory, where the computer executable components can comprise an access component that can access an input dataset. The computer executable components can further comprise a data generation component that can generate, based on the input dataset, a plurality of new datasets by employing a plurality of quantum kernels.

### BACKGROUND

The subject disclosure relates to quantum computing and, more specifically, to data classification based on quantum kernels.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable data classification based on quantum kernels are discussed.

According to an embodiment, a system is provided. The system can comprise a memory that can store computer executable components. The system can further comprise a processor that can execute the computer executable components stored in the memory, where the computer executable components can comprise an access component that can access an input dataset. The computer executable components can further comprise a data generation component that can generate, based on the input dataset, a plurality of new datasets by employing a plurality of quantum kernels. As used herein, the terms “new dataset” and “new input dataset” mean a version of the input dataset modified by overbalancing or under balancing. As used herein, the terms “new datasets” and “new input datasets” mean versions of the input dataset modified by overbalancing or under balancing.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can employ quantum kernels to generate new data and perform data classification tasks in accordance with one or more embodiments described herein.

FIG. 2 illustrates another block diagram of an example, non-limiting system that can employ quantum kernels to generate new data and perform data classification tasks in accordance with one or more embodiments described herein.

FIG. 3 illustrates a flow diagram of an example, non-limiting method that can employ quantum kernels to generate new data and perform data classification tasks in accordance with one or more embodiments described herein.

FIG. 4 illustrates example, non-limiting processes that describe an oversampling technique.

FIG. 5 illustrates an example, non-limiting table showing experimental results in accordance with one or more embodiments described herein.

FIG. 6 illustrates example, non-limiting graphs showing experimental data clustering results in accordance with one or more embodiments described herein.

FIG. 7 illustrates example, non-limiting graphs showing experimental training and test results in accordance with one or more embodiments described herein.

FIG. 8 illustrates a flow diagram of an example, non-limiting method that can employ quantum kernels to generate new data in accordance with one or more embodiments described herein.

FIG. 9 illustrates a flow diagram of an example, non-limiting method that can be employed to select a pair of quantum kernels to perform data generation and classification in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise an access component that can access an input dataset. The computer executable components can further comprise a data generation component that can generate, based on the input dataset, a plurality of new datasets by employing a plurality of quantum kernels.

Such embodiments of the system can provide the advantage of employing quantum computing to generate new datasets that can be employable in quantum machine learning (QML)-based data classification tasks.

In one or more embodiments of the aforementioned system, the data generation component can further transform a data distribution of the input dataset into respective new data distributions by employing respective quantum kernels of the plurality of quantum kernels. The data generation component can further generate respective new datasets of the plurality of new datasets by oversampling or under sampling data from the respective new data distributions. The data generation component can further generate respective classification datasets based on the respective new datasets, where a classification dataset based on a new dataset can comprise the input dataset and the new dataset.

Such embodiments of the system can provide a number of advantages, including employing quantum kernels to capture the data distribution in an input dataset and generate multiple new data distributions, generating multiple new datasets based on the data distributions, and generating multiple classification datasets that can be employed in QML-based data classification tasks and that can be employed to train different machine learning models for QML-based data classification tasks.

In one or more embodiments of the aforementioned system, a quantum kernel selection component can randomly select a quantum kernel from the plurality of quantum kernels, where the quantum kernel can be employed to generate a new dataset of the plurality of new datasets.

Such embodiments of the system can provide a number of advantages, including employing quantum kernels to capture the data distribution in an input dataset, and generating multiple new data distributions that can be employed to generate classification datasets for QML-based data classification.

In one or more embodiments of the aforementioned system, a data classification component can classify the respective classification datasets by employing the plurality of quantum kernels.

Such embodiments of the system can provide the advantage of leveraging the abilities of quantum computing to classify data and perform computations more efficiently than classical systems, potentially speeding up quantum kernel computations and classification tasks.

In one or more embodiments of the aforementioned system, a storage component can store results of classification of the respective classification datasets in a storage.

Such embodiments of the system can provide the advantage of making the results accessible for further analysis.

In one or more embodiments of the aforementioned system, an analysis component can analyze the results. The analysis component can further generate, based on analysis of the results, classification scores corresponding to quantum kernels comprised in the plurality of quantum kernels.

Such embodiments of the system can provide a number of advantages, including determining the accuracies of respective performances of respective quantum kernels on data generation and data classification tasks, and comparing the respective accuracies.

In one or more embodiments of the aforementioned system, a quantum kernel identification component can select, based on the classification scores, a first quantum kernel, where the first quantum kernel can be employable to generate a new dataset based on the original dataset through balancing. The quantum kernel identification component can further select, based on the classification scores, a second quantum kernel, where the second quantum kernel can be employable to classify data comprised in the new dataset.

Such embodiments of the system can provide a number of advantages, including identifying the best quantum kernel for data generation from a set of quantum kernels, and identifying the best quantum kernel for data classification from the set of quantum kernels.

In one or more embodiments of the aforementioned system, the plurality of quantum kernels can be quantum feature maps.

Such embodiments of the system can provide the advantage of employing quantum computing to generate new datasets and to perform QML-based data classification tasks.

An embodiment in which the data generation component can transform a data distribution of the input dataset into respective new data distributions by employing respective quantum kernels of the plurality of quantum kernels, generate respective new datasets of the plurality of new datasets by oversampling data (e.g., generating synthetic data) from the respective new data distributions, and generate respective classification datasets based on the respective new datasets, can provide a number of advantages, including employing quantum kernels to capture the data distribution in the input dataset and generate multiple new data distributions, generating multiple new datasets based on the data distributions, and generating multiple classification datasets that can be employed in QML-based data classification tasks and that can be employed to train different machine learning models for QML-based data classification tasks, where the classification datasets can comprised balanced data in the majority and minority classes.

An embodiment in which the data generation component can transform a data distribution of the input dataset into respective new data distributions by employing respective quantum kernels of the plurality of quantum kernels, generate respective new datasets of the plurality of new datasets by under sampling data (e.g., clustering or otherwise reducing data) from the respective new data distributions, and generate respective classification datasets based on the respective new datasets, can provide a number of advantages, including employing quantum kernels to capture the data distribution in the input dataset and generate multiple new data distributions, generating multiple new datasets based on the data distributions, and generating multiple classification datasets that can be employed in QML-based data classification tasks and that can be employed to train different machine learning models for QML-based data classification tasks, where the classification datasets can comprised balanced data in the majority and minority classes.

Thus, one or more embodiments can select a quantum kernel from a set in the outer loop to be used for data generation for oversampling of minority class or data clustering for under sampling of majority class. Then with this quantum kernel from the outer loop in the inner loop the embodiment can employ the same set of quantum kernels and classify taking each from that set and store the results. Once the inner loop quantum kernels are exhausted, the embodiment can go back to the outer loop and pick the next quantum kernel there for balancing and this method can continue until the quantum kernels in the outer loop are exhausted. Then the embodiment can select the best result and choose that pair of quantum kernels (e.g., outer for balancing, inner to classify). As a result, this embodiment provides a completely automated approach to an advantageous method of quantum kernel balancing and classifying.

In an embodiment, the above described system can be employed in data classification tasks such as in binary classifications, multi-class classification, or other types of data classification tasks. For example, the above described system can be employed to train a machine learning model on balanced data generated via quantum kernels, and the trained machine learning model can be employed in a data classification task to detect anomalies related to financial transactions, data breaches, etc.

According to various embodiments, the above-described system can be implemented as a computer-implemented method or as a computer program product.

A significant application of QML is in kernel-based methods of data classification for several use cases, and especially in tasks such as anomaly detection (e.g., related to financial scams, cybersecurity, etc.). Datasets employed in such use cases can typically comprise a target class and a non-target class, wherein the target class can typically comprise a significantly smaller number of data points than those comprised in a non-target class. For example, in the category of financial transactions, the target class can comprise data points related to a small number of unfavorable or suspicious transactions, and the non-target class can comprise data points related to a large number of regular or unsuspicious transactions. For example, there can exist no suspicious transactions within 100 transactions, but there can exist one or two suspicious transactions within 10,000 transactions. Accordingly, the target class can be referred to as a minority class, and the non-target class can be referred to as the majority class. If a machine learning model is trained on a dataset comprising such minority and majority classes, the machine learning model can exhibit bias towards the majority class, and the minority class can be entirely ignored by the machine learning model when generating predictions. Thus, it can be desirable to balance the data in the minority and majority classes in a dataset to make the two classes comparable in size (i.e., the number of data points) prior to employing such a dataset in data classification tasks. This can be achieved either by oversampling the data points in the minority class, or by under sampling the data points in the majority class.

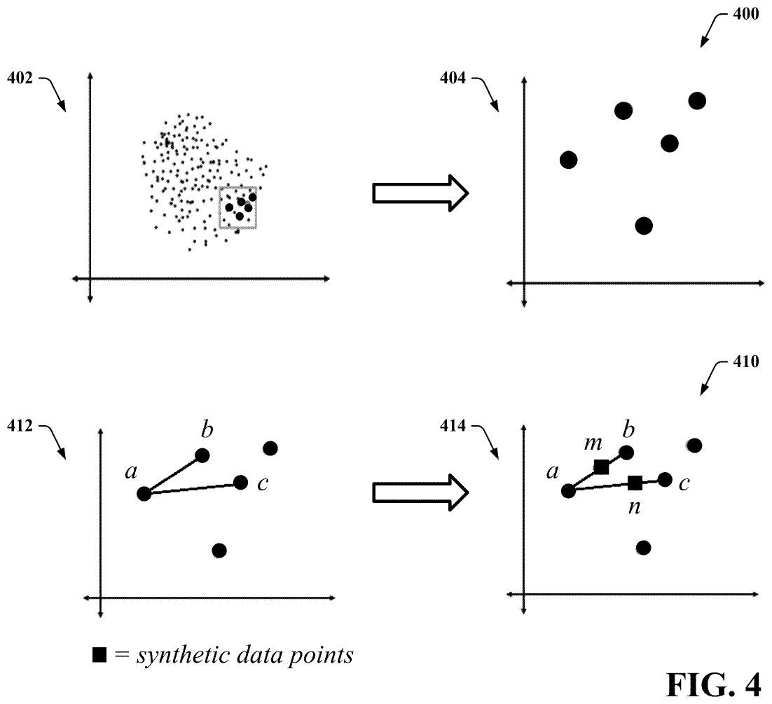

Existing approaches typically employ an oversampling technique called Synthetic Minority Oversampling Technique (SMOTE) to balance data in different classes a dataset. The mechanism behind SMOTE is described in greater detail with reference to FIG. 4. However, SMOTE is a classical technique that can be employed in synthetic data generation/data clustering or data balancing, and employing SMOTE to generate new data and further employing quantum kernels to perform data classification based on the new data can be a mismatch due to the fundamental differences between classical processing and quantum processing. For example, balancing data classically can miss out on the computational advantages such as superposition, interference and entanglement offered by quantum computing, or the classical techniques employed to balance the data may not align well with the way data is processed in quantum computing. That is, when employing quantum methods to classify data comprised in a balanced classification dataset (i.e., a dataset having comparable numbers of data points in the minority and majority classes), it can be desirable to generate the classification dataset (e.g., by oversampling or under sampling existing data points) via quantum methods rather than in a classical fashion.

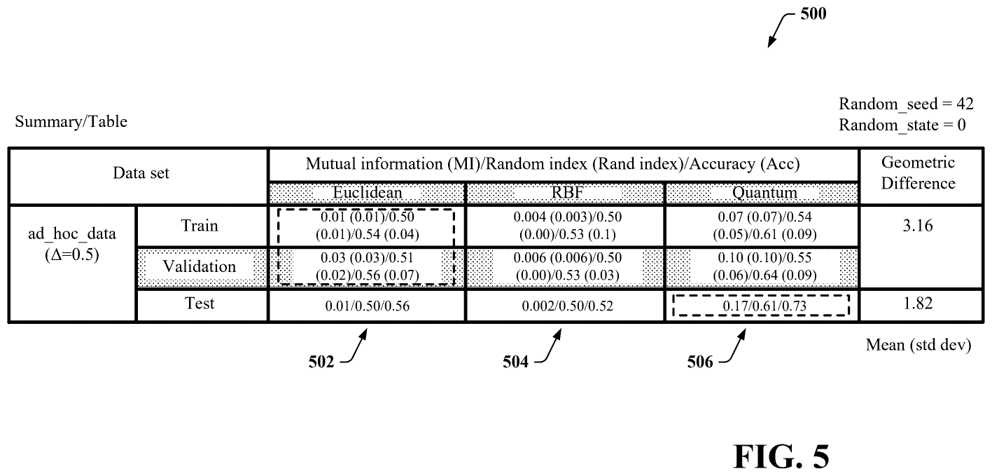

Accordingly, embodiments described herein include systems, computer-implemented methods, and computer program products that can employ quantum kernel-based methods to balance data in a dataset comprising a majority class and a minority class, instead of employing classical techniques such as SMOTE. For example, in one or more embodiments, a set of quantum kernels can be employed to generate synthetic data points by oversampling data, and another set of quantum kernels can be employed to compare the test results of a data classification based on the synthetic data points. Alternatively, in one or more embodiments, a set of quantum kernels can be employed to perform clustering-based under sampling based on K-means, K-medoids or other techniques, and another set of quantum kernels can be employed to compare the test results of a data classification based on the clustered data points. Further, the various embodiments herein can automatically determine the most appropriate quantum kernels to be employed to generate new data by oversampling or under sampling and to subsequently perform data classification based on the new data to generate the best test results. In this regard, experimental results presented with reference to FIG. 5-7 show that quantum kernels selected by the methods and techniques described in various embodiments can perform optimal data classification with a greater classification accuracy as compared to existing techniques.

In various embodiments, a data classification model can automatically select the most appropriate quantum kernel to oversample or under sample data and select the most appropriate quantum kernel to perform data classification. In various embodiments, the data classification component can employ an access component to access an input dataset comprising majority and minority classes of data. In various embodiments, a quantum kernel selection component can randomly select a quantum kernel from a set of quantum kernels, and a data generation component can employ the quantum kernel to oversample or under sample data comprised in the input dataset. As a result, a new dataset comprising either synthetic data points resulting from oversampling data or clustered data points resulting from under sampling the data can be generated. The process of generating the new dataset can be executed by the data generation component on a quantum computer or a classical simulator of a quantum computer, wherein the quantum kernel can process the input dataset via a quantum circuit. The data generation component can further generate a classification dataset based on the new dataset, wherein the classification dataset can comprise the input dataset and the new dataset. In various embodiments, a data generation component can generate data comprised in the classification dataset by consecutively applying quantum kernels from the set of quantum kernels. As such, the data classification component can perform multiple consecutive data classification tasks wherein a different quantum kernel can be applied to the classification dataset during each data classification task. In various embodiments, once all the quantum kernels applicable to the classification dataset have been exhausted, the quantum kernel selection component can randomly select a different quantum kernel from the set of quantum kernels, and data generation component can employ the selected quantum kernel to generate another new dataset. In various embodiments, the process can continue as described until all the quantum kernels in the set of quantum kernels have been employed to generate new data and perform data classification based on the new data. In various embodiments, a storage component can store the results of classification tasks performed by data classification component during the entire process, in a storage, and an analysis component can analyze the results. Analysis component can analyze the results and generate classification scores for quantum kernels comprised in the set of quantum kernels. In various embodiments, a quantum kernel identification component can identify, based on the analysis, a first kernel that can most accurately generate a new dataset based on the original dataset through balancing and further identify a second kernel that can most accurately classify data comprised in the new dataset. For example, according to a computer-implemented method, QML classification can be performed on an input dataset. Based on quantum kernels selected for the QML classification, a new dataset comprising synthetic data or under sampled data can be respectively generated by oversampling or under sampling data from the input dataset via a first quantum kernel. Thereafter, the QLM classification can be performed on the input dataset and the new dataset via a second quantum kernel.

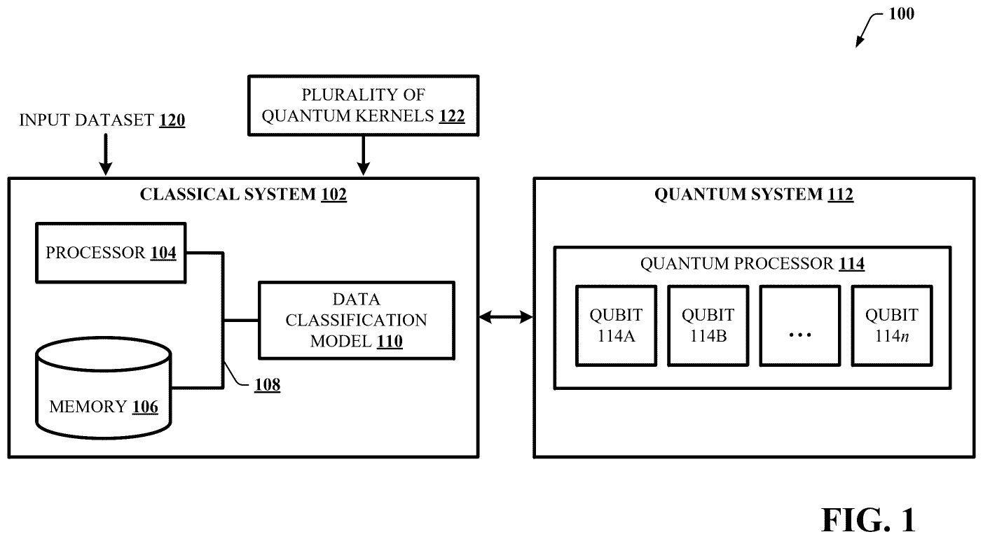

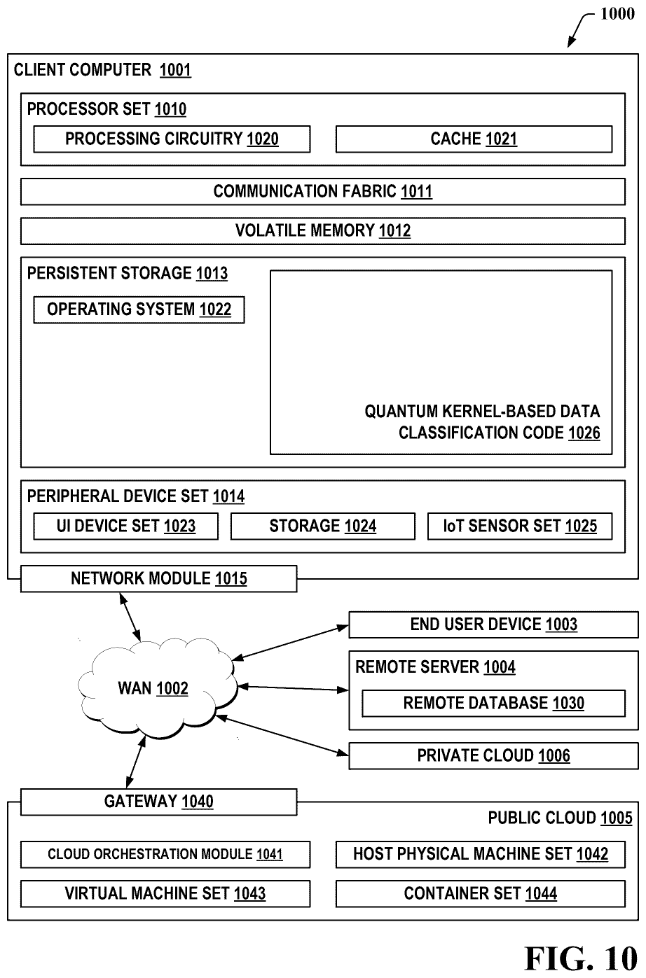

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, a computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can employ quantum kernels to generate synthetic data and perform data classification tasks in accordance with one or more embodiments described herein.

Non-limiting system 100 and/or the components of non-limiting system 100 can be employed to use hardware and/or software to solve problems that are highly technical in nature (e.g., related to QML, data classification, quantum kernels, etc.), that are not abstract and that cannot be performed as a set of mental acts by a human. Further, some of the processes performed may be performed by specialized computers for carrying out defined tasks related to data classification based on quantum kernels. Non-limiting system 100 and/or components of the system can be employed to solve new problems that arise through advancements in technologies mentioned above and/or the like. Non-limiting system 100 can provide improvements to QML procedures by identifying quantum kernels that can most accurately generate new data by oversampling data in a minority dataset or by under sampling data in a majority dataset, and by identifying quantum kernels that can most accurately classify data. The methods and techniques disclosed in various embodiments herein can generate more accurate classification results as compared to certain existing techniques.

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 114. Classical system 102 can comprise one or more components, such as a memory 106, processor 104, bus 108, and/or data classification model 110. In an embodiment, data classification model 110 can be comprised at least partially by quantum system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit.

Discussion turns briefly to processor 104, memory 106 and bus 108 of non-limiting system 100. For example, in one or more embodiments, the non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., data classification model 110, access component 202, quantum kernel selection component 204, data generation component 206, data classification component 208, storage component 210, analysis component 212, quantum kernel identification component 214 and/or training component 216) to perform one or more actions. In one or more embodiments, memory 106 can store computer-executable components (e.g., data classification model 110, access component 202, quantum kernel selection component 204, data generation component 206, data classification component 208, storage component 210, analysis component 212, quantum kernel identification component 214 and/or training component 216).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

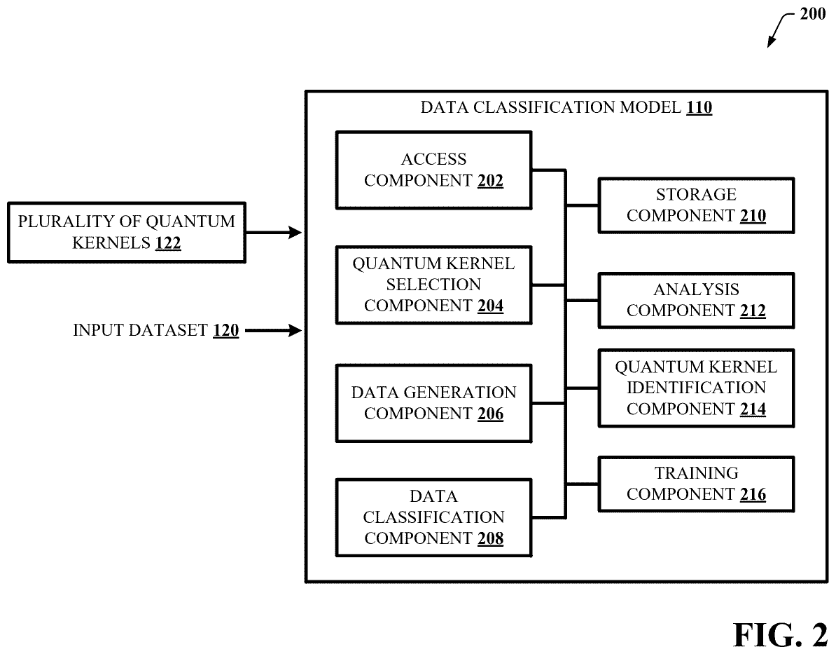

In various embodiments, classical system 102 can comprise data classification model 110. As illustrated in FIG. 2, data classification model 110 can further comprise access component 202, quantum kernel selection component 204, data generation component 206, data classification component 208, storage component 210, analysis component 212, quantum kernel identification component 214 and training component 216. Classical system 102 can be coupled (operatively, communicatively, electrically, and/or like function) to quantum system 112 to perform the operations described by the various embodiments herein.

Input dataset 120 can comprise different classes of data with unequal numbers of data points. For example, input dataset 120 can be a dataset employable to train a machine learning model to perform a data classification task such as binary classifications, multi-class classifications, multi-label classifications, etc. For example, input dataset 120 can be employable to train a machine learning model to detect anomalies related to financial transactions.

Accordingly, input dataset 120 can comprise 100,000 data points belonging to an unsuspicious transaction class and 100 data points belonging to a suspicious transaction class. However, training a machine learning model for a data classification task by employing classes of data comprising unequal numbers of data points, wherein the number of data point in one class (majority class) are significantly more that the number of data points in another class (minority class), can cause the machine learning model to become biased towards the majority class. Thus, it can be desirable to balance the numbers of data points in different classes of data employed to train a machine learning model. Additionally, in the case of QML, wherein quantum computing techniques are employed to classify data, it can be further desirable to also employ quantum computing techniques to balance the data. Accordingly, various embodiments described herein can employ data classification model 110 to identify the best quantum kernels that can be employed to balance the number of data points in different classes comprised in an input dataset, and to further classify the balanced data.

For example, in various embodiments, access component 202 can access input dataset 120. In various embodiments, data generation component 206 can generate, based on input dataset 120, a plurality of new datasets by employing a plurality of quantum kernels. For example, in various embodiments, data generation component 206 can transform a data distribution of input dataset 120 into respective new data distributions by employing respective quantum kernels comprised in plurality of quantum kernels 122. Thereafter, data generation component 206 can generate respective new datasets of the plurality of new datasets by oversampling or under sampling data from the respective new data distributions. Finally, data generation component 206 can generate respective classification datasets based on the respective new datasets, wherein a classification dataset based on a new dataset can comprise input dataset 120 and the new dataset. Each new dataset can comprise either synthetic data points that can typically result from oversampling data, or under sampled data points that can typically result from clustering data points. A quantum kernel employed by data generation component 206 to generate a new data distribution and subsequently generate a synthetic dataset can be randomly selected by quantum kernel selection component 204 from plurality of quantum kernels 122. In various embodiments, data classification component 208 can classify the respective classification datasets generated by data generation component 206 by employing the plurality of quantum kernels 122. In various embodiments, storage component 210 can store results of classification of the respective classification datasets in a storage.

More specifically, in various embodiments, quantum kernel selection component 204 can randomly select a quantum kernel from plurality of quantum kernels 122. Each quantum kernel comprised in plurality of quantum kernels 122 can be defined as a feature map or unitary that carries out a data-point-dependent unitary transformation on n-qubits. For example, a quantum kernel comprised in plurality of quantum kernels 122 can be a ZZ feature map that can be constructed via a Pauli expansion circuit. In quantum computing, quantum kernels can be employed to encode classical data having a set of classical features and obtain, based on the encoded classical data, a different set of classical features. Accordingly, in various embodiments described herein, a quantum kernel can be employed to transfer a set of classical features to another set of classical features. The form of classical features thus obtained can be more separable via classical techniques. For example, data generation component 206 can employ the quantum kernel to transform a data distribution of input dataset 120 into a new data distribution. For example, data generation component 206 can apply the quantum kernel to input dataset 120 by executing a quantum circuit on quantum system 112 or a classical simulator of a quantum system. As a result, a classical data distribution of input dataset 120 can be transformed into a new classical data distribution, based on the quantum kernel.

In various embodiments, data generation component 206 can employ the new data distribution to generate new data by oversampling or under sampling data points organized according to the new data distribution. Oversampling refers to increasing the number of data points in the minority class by generating copies of existing data points (e.g., synthetic data) to make the number of data points in the minority class comparable to those in the majority class. Under sampling refers to reducing the number of data points in the majority class using a clustering-based approach to make the number of data points in the majority class comparable to those in the minority class. Data generation component 206 can determine whether to oversample or under sample data points based on the specific application for input dataset 120 and automatically oversample or under sample the data accordingly to the determination. The process of generating the new dataset can be performed on classical system 102. Based on the new dataset, data generation component 206 can further generate a classification dataset by combining input dataset 120 and the new dataset thus generated. The classification dataset can comprise comparable numbers of data points in the majority and minority classes.

In various embodiments, data classification component 208 can classify data comprised in the classification dataset by employing multiple quantum kernels comprised in the plurality of quantum kernels 122. In some implementations, data classification component 208 can employ all quantum kernels comprised in the plurality of quantum kernels 122 to classify the data in the classification dataset. In one or more embodiments, data classification component 208 can apply the quantum kernels to the classification dataset in a consecutive manner. For example, the plurality of quantum kernels 122 can comprise feature maps such as Z, ZZ, XY, XZ, etc., wherein X, Y and Z can respectively represent a Pauli-X gate, a Pauli-Y gate and a Pauli-Z gate. Data classification component 208 can perform multiple data classification tasks on the classification dataset by employing a different feature map during each data classification task. For example, data classification component 208 can employ the XY feature map during a first data classification, the ZZ feature map during a second data classification, and so on. The data classification tasks can be performed on classical system 102, for example, on a classical simulator of a quantum system, wherein data classification component 208 can apply quantum kernels to the classification dataset by implementing respective quantum kernels as respective quantum circuits.

### Data Classification with Quantum Kernels

In one or more embodiments, to classify data with quantum kernels, classical data can be encoded into quantum states via quantum feature map. The feature map can be applied to the classical data via a quantum circuit that can be executed on a quantum computer or a classical simulator of a quantum computer to obtain the quantum states. Thereafter, quantum kernel values can be computed for pairs of data points, and a kernel matrix can be computed based on the quantum kernel calculation. The kernel matrix can be employed to train a machine learning model (e.g., data classification component 208) such as an SVM model or another machine learning model. The trained machine learning model can be deployed to classify new data such as data comprised in the classification dataset, wherein the trained machine learning model can encode classical data points, such as data comprised in the classification dataset, by employing a quantum feature map. Further, the trained machine learning model can compute kernel values for the classical data points, compute a kernel matrix based on the kernel values and employ the kernel matrix to perform data classification.

The data classification process executed by data classification component 208 can continue until the list of quantum kernels applicable to the classification is exhausted.

Thereafter, quantum kernel selection component 204 can select another quantum kernel from the plurality of quantum kernels 122, and data generation component 206 can automatically generate a new dataset based on the quantum kernel. Data comprised in the new dataset can be further classified by data classification component 208 by employing multiple quantum kernels from the plurality of quantum kernels 122. The cycle of generating classification data based on input dataset 120 and classifying the classification data can continue until each quantum kernel from the plurality of quantum kernels 122 has been employed to generate a classification dataset and classify the classification dataset. In various embodiments, storage component 210 can store the results of the various classifications in a storage (e.g., memory 106 or another form of storage).

In various embodiments, analysis component 212 can analyze the results. Analysis component 120 can employ various classical metrics or an average of a series of metrics to analyze the results. For example, for binary classifications, analysis component 120 can employ metrics such as Area Under the Curve (AUC), accuracy or F1 scores, etc. or an average of such metrics. In one or more embodiments, the outcomes of the analysis can be displayed to an entity (e.g., hardware, software, machine, artificial intelligence (AI), neural network and/or user) at a user interface (UI) of a device (e.g., desktop computer, laptop, tablet, smartphone, etc.).

Based on the analysis, analysis component 120 can generate classification scores corresponding to quantum kernels comprised in the plurality of quantum kernels 122. For example, in some embodiments, analysis component 120 can generate respective classification scores corresponding to respective pairs of quantum kernels, wherein a first quantum kernel in a pair of quantum kernels can be a quantum kernel employed to generate a classification dataset, and a second quantum kernel in the pair of quantum kernels can be a different quantum kernel employed to classify data in the classification dataset. For example, a classification score corresponding to a pair of quantum kernels can be the outcome of a metric or multiple metrics (e.g., AUC, F1 scores, etc.) that can indicate the data classification performance of data classification component 208 based on the pair of quantum kernels. In other embodiments, analysis component 120 can generate respective first scores and respective second scores for the respective quantum kernels. The respective first scores can correspond to data generation, and the respective second scores can correspond to data classification. For example, a first score for a quantum kernel can be the outcome of a metric or multiple metrics (e.g., AUC, F1 scores, etc.) that can indicate the data generation performance of data generation component 206 based on the quantum kernel. Similarly, a second score for the quantum kernel can be the outcome of a metric or multiple metrics (e.g., AUC, F1 scores, RMS, etc.) that can indicate the data classification performance of data classification component 208 based on the quantum kernel.

In various embodiments, quantum kernel identification component 214 can select, based on the respective classification scores, a first quantum kernel and a second quantum kernel from the plurality of quantum kernels 122, wherein the first quantum kernel can be employable to generate a new dataset based on the original dataset through balancing, and the second quantum kernel can be employable to classify data comprised in the new dataset. For example, in some embodiments, quantum kernel identification component 214 can select a pair of quantum kernels having a classification score greater than a defined accuracy threshold. In other embodiments, quantum kernel identification component 214 can select a quantum kernel having a first score greater than a first defined accuracy threshold and select another quantum kernel having a second score greater than a second defined accuracy threshold. The pair of quantum kernels thus selected by quantum kernel identification component 214 can be employed by data generation component 206 to generate a new dataset and further employed by data classification component 208 to classify data in the new dataset. For example, input dataset 120 can comprise data related to financial transactions. Upon selection of the pair of quantum kernels by quantum kernel identification component 214, data classification model 110 can employ the pair of quantum kernels to perform data classification on a new input dataset, wherein the new input dataset can comprise different data related to financial transactions.

The various embodiments described herein can represent a QML-based testing process or quantum kernel testing procedure, wherein different feature engineering methods are tested to identify the best quantum kernel to over sample or under sample data and perform data classification. For example, the various embodiments described herein can be employed to identify a quantum kernel that can most accurately transfer a classical data distribution to a new classical data distribution and generate a classification dataset based on the new classical data distribution. The various embodiments herein can be further employed to identify another quantum kernel that can most accurately classify data comprised in the classification dataset. The various embodiments described herein can also represent a QML-based testing process for a machine learning model. For example, in one or more embodiments, data classification component 208 can be a machine learning model that can be trained to employ quantum kernels to classify data. As data is classified by data classification component 208 via different quantum kernels, the performance of data classification component 208 can also be assessed via the classification scores generated by analysis component 120. In one or more embodiments, training component 216 can employ the classification datasets generated by data generation component 206 to train one or more machine learning models for various data classification tasks.

FIG. 2 illustrates a block diagram of an example, non-limiting system 200 that can employ quantum kernels to generate new data and perform data classification tasks in accordance with one or more embodiments described herein. Repetitive description of like elements and/or processes employed in respective embodiments is omitted for sake of brevity.

FIG. 2 illustrates the system of data classification model 110 of FIG. 1. As previously stated, data classification model 110 can comprise access component 202, quantum kernel selection component 204, data generation component 206, data classification component 208, storage component 210, analysis component 212, quantum kernel identification component 214 and training component 216. In one or more embodiments, one or more components comprised in data classification model 110 can be machine learning models. In some embodiments, data classification model 110 can be a multi-stage machine learning model, wherein individual machine learning models can perform the operations described with reference to FIG. 1 to identify a pair of quantum kernels that can most accurately classify an input dataset, and wherein the outcome of one machine learning model can be employed by another machine learning model to identify the pair of quantum kernels. The pair of quantum kernels can be selected from the plurality of quantum kernels 122 and tested based on input dataset 120.

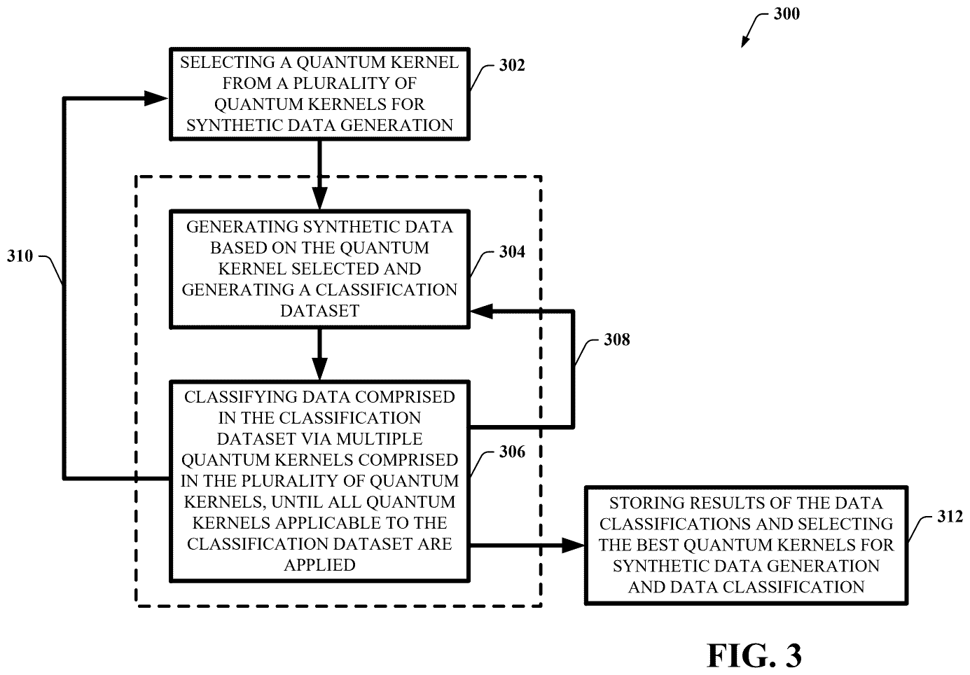

FIG. 3 illustrates a flow diagram of an example, non-limiting method 300 that can employ quantum kernels to generate new data and perform data classification tasks in accordance with one or more embodiments described herein. Repetitive description of like elements and/or processes employed in respective embodiments is omitted for sake of brevity.

Non-limiting method 300 summarizes the automatic/automated quantum process/program flow with quantum kernel-based data balancing and classification described with reference to FIGS. 1 and 2.

At 302, non-limiting method 300 can comprise selecting (e.g., by quantum kernel selection component 204) a quantum kernel (e.g., a feature map such as Z, ZZ, XY, XZ, etc. or another quantum kernel) from a plurality of quantum kernels to generate (e.g., by oversampling or under sampling) new data (e.g., synthetic data).

At 304, non-limiting method 300 can comprise generating (e.g., by data generation component 206) the new data based on the quantum kernel selected and further generating a classification dataset based on the new data, wherein the classification dataset can comprise balanced data (i.e., comparable numbers of data points in the minority and majority classes).

At 306, non-limiting method 300 can comprise classifying (e.g., by data classification component 208) data comprised in the classification dataset via multiple quantum kernels comprised in the plurality of quantum kernels, until all quantum kernels applicable to the classification dataset have been applied.

For example, non-limiting method 300 can comprise performing (e.g., by data classification component 208) multiple data classification tasks on data comprised in the classification dataset by employing a different quantum kernel during each data classification task. For example, data classification component 208 can select and employ the Z feature map during a first data classification, the ZZ feature map during a second data classification, and so on. In non-limiting method 300, the process of consecutively applying different quantum kernels to classify data in the classification dataset is illustrated as a nested inner loop at 308. In this regard, the rectangle with dashed lines can represent the portion of non-limiting method 300 wherein automatic data generation (e.g., via oversampling or under sampling) and classification testing can occur.

Once the list of quantum kernels employed to classify the data is exhausted, then at 310, non-limiting method 300 can exit the nested inner loop and return to 302, wherein non-limiting method 300 can comprise selecting (e.g., by quantum kernel selection component 204) a different quantum kernel (e.g., a feature map such as Z, ZZ, XY, XZ, etc. or another quantum kernel) from a plurality of quantum kernels to generate (e.g., by oversampling or under sampling) another new dataset. This step represents the outer loop of non-limiting method 300.

At 312, non-limiting method 300 can comprise storing (e.g., by storage component 210) results of the data classification tasks and selecting (e.g., by quantum kernel identification component 214) the best quantum kernels for new data generation and data classification. For example, based on the results of the data classification, quantum kernel identification component 214 can select (in a manner similar to performing a grid search) a pair of quantum kernels that can generate the most accurate data classification, wherein a first quantum kernel of the pair of quantum kernels can correspond to the outer loop processes of non-limiting method 300, and a second quantum kernel of the pair of quantum kernels can correspond to the nested inner loop processes of non-limiting method 300.

FIG. 4-7 are intended to describe the advantages of the embodiments of the present disclosure over existing data classification techniques.

FIG. 4 illustrates example, non-limiting processes 400 and 410 that describe an oversampling technique. Repetitive description of like elements and/or processes employed in respective embodiments is omitted for sake of brevity.

Non-limiting processes 400 and 410 describe the SMOTE approach. SMOTE is a classical oversampling technique in which new synthetic samples (observations or data points) are created using existing samples in a minority class of data. For example, synthetic (virtual) training records are generated by linear interpolation of samples comprised in the minority class. The synthetic training records are generated by randomly selecting one or more of the k-nearest neighbors for each example in the minority class. After the oversampling process, data is reconstructed, and several classification models can be applied to the processed data. SMOTE comprises the following steps:

Step 1: Setting a minority class set A, for each data point x in A ($x \in A), the k-nearest neighbors of x are obtained by calculating the Euclidean distance between x and every other sample in the minority class set A.

Step 2: The sampling rate N is set according to the proportion of imbalanced data. For each x in A ($x \in A), N examples (i.e., x1, x2, . . . xn) are randomly selected from its k-nearest neighbors, and they are employed to construct a set A_1 ($A_1$).

Step 3: For each example x_k in A_1 ($x_k \in A_1$), wherein k=1, 2, 3, . . . , N, the formula x′=x+rand(0, 1)*(mid(x−x_k)) (or, $x′=x+rand(0, 1)*\mid x−x_k \mid$) is employed to generate a new example, where rand(0, 1) denotes a random number between 0 and 1.

If the value of a k-nearest neighbor is 2, then each data point will find its nearest two neighbors (e.g., using Euclidean distance). For example, if only the data point a is initially considered, then data points b and c can be the two nearest neighbors of a. By employing Step 3 of the algorithm, new synthetic points can be generated. One or more synthetic samples can be generated on each line, depending on the number of synthetic samples desired. A single line can accommodate multiple synthetic points. In SMOTE, all data points in the minority class A are considered and synthetic observations are similarly generated for each data point.

SMOTE considers the differences between different data points in a minority class of data to generate an average of the different data points. For example, as described herein, a new data point can be generated by averaging two existing data points in the minority class. In non-limiting process 400, graph 402 shows an initial distribution of data points comprising a majority class of data (smaller dots) and a minority class of data (larger dots enclosed within the square). In SMOTE, minority samples from graph 402 can be considered for oversampling, as shown by graph 404. Turning to non-limiting process 410, graph 412 shows data points a, b and c of the minority samples shown in graph 404, wherein b and c can represent the two k-nearest neighbors of a. Graph 414 shows synthetic data points m and n that can be respectively generated between a and the two k-nearest neighbors of a, b and c, via SMOTE. Although SMOTE can generate synthetic data points by oversampling, the pair of points employed to generate the synthetic data points can be randomly selected, which is not the most accurate technique to oversample data.

In some other existing techniques, data points in a majority class of data can be clustered to generate different chunks or clusters of data point, and each cluster of data points can be employed to generate a new data point, wherein the new data point based on a cluster can be the mid-point of the cluster generated via techniques such as K-means clustering, etc. For example, to under sample the data points in an initial distribution, such existing techniques can replace a cluster with the mid-point or the centroid of the cluster. Clustering can generate a better distribution of data or generate better data rather than randomly selecting data points and averaging the data point, such as in SMOTE), because in clustering, the original data distribution of data is considered rather than randomly selecting data points and averaging the data points. Considering how data is distributed or organized in an initial distribution can generate a better data distribution of the new data points generated via oversampling or under sampling.

In general, oversampling and under sampling can be performed by randomly selecting or eliminating data points. However, such techniques do not account for the structure and distribution of data. Embodiments of the present disclosure can eliminate the randomness inherent in SMOTE and/or other techniques and employ a more strategic and efficient approach to generating new data. Additionally, the embodiments of the present disclosure can employ quantum computing to generate the new data. For example, the various methods and techniques described herein can account for the distribution of data in an initial distribution of data points by employing quantum kernels to generate new data by oversampling or under sampling. For example, each quantum kernel (e.g., a quantum feature map or another quantum kernel) can generate a different data distribution based on the distribution of data in input dataset 120, and each different data distribution can result in a new dataset. Each new dataset thus generated can comprise data having a unique pattern, and the new datasets generated via different kernels can be employed in data classification tasks to produce different outcomes. In some embodiments, the different new datasets with different data patterns can be employed to train (e.g., by training component 216) different machine learning models that can be employed for data classification. By employing quantum kernels to generate synthetic data based on embedded patterns in an initial distribution of data and to perform data classification, the various embodiments herein can provide more efficient methods and techniques for QML. In theory, classical functions can be described as a subset of quantum functions. Quantum functions can generate arbitrary functions that can be more efficient than classical functions given the nature of entanglement in the quantum space. As such, in experiments conducted with synthetic datasets, it was observed that quantum kernels performed better than classical kernels in terms of accuracy.

FIG. 5 illustrates an example, non-limiting table 500 showing experimental results in accordance with one or more embodiments described herein. Repetitive description of like elements and/or processes employed in respective embodiments is omitted for sake of brevity.

With continued reference to FIG. 1-4, non-limiting table 500 shows a comparison of experimental results that were generated by employing different techniques to cluster ad hoc data. In non-limiting table 500, column 502 shows results based on the Euclidean distance technique, column 504 shows results based on a Radial Basis Function (RBF) kernel, and column 506 shows results based on a ZZ feature map generated via a Pauli expansion circuit (embodiments of the present disclosure). The Euclidean distance technique and RBF kernel technique are classical techniques. To generate the experimental results shown in non-limiting graph 500, each selected technique (i.e., Euclidean distance, RBF kernels and quantum kernels) was employed to transform input data from one distribution to a new distribution, and the K-medoids technique was employed to perform data clustering based on the new distribution. In each scenario, the data transformation and clustering was performed by a machine learning model trained on ground truth data. The K-medoids technique is also a classical technique that employs the K-medoids clustering algorithm, wherein the K-medoids clustering algorithm considers an actual data point as the center (i.e., medoid) of a cluster of data points. The calculations for the quantum K-medoids technique (i.e., K-medoids with a Pauli expansion circuit) were performed by employing ‘affinity’ as a distance metric.

Each technique (i.e., Euclidean distance, RBF kernel and ZZ feature map generated via a Pauli expansion circuit) was executed on a classical simulator of a quantum computer. Non-limiting table 500 shows a comparison of training, validation and test results corresponding to the respective techniques. A random seed value of forty-two and a random state value of zero was defined for the experiments. Random seed and random state can be values that can be provided to a random number generator to select different portions of large dataset for experimentation. Different random seed and random state values can lead to different distributions of data being selected from a larger data population. This is because in quantum computing, a large dataset (e.g., 100,000 data points) can be a significant amount of data for a quantum computing system (e.g., a quantum computer or a classical simulator of a quantum computer) to process, especially while the data is also being processed elsewhere, and thus, a portion of a large dataset is typically selected for experimentation. The random seed and random state values can also be employed to reproduce experiments.

To evaluate the different clustering techniques, the mutual information (MI), random index and accuracy metrics were employed. According to the MI metric, a higher score indicates a better performance. In non-limiting table 500, the training, validation and test results are organized as MI/random index/accuracy values. Evidently, the test scores show that employing a quantum kernel, as described by the various embodiments herein, can generate better clustering than classical techniques. For example, the random index values of 0.50 for the test scores in columns 502 and 504 indicate that the classical techniques (i.e., the Euclidean distance technique and the RBF kernel technique) can generate a random guess at best (50%), whereas the K-medoids with the Pauli expansion circuit can generate a random index value of 0.61 for the test scores, as seen from column 506. Similarly, the test scores also show a 73% accuracy value for the K-medoids with the Pauli expansion circuit technique versus only 52% and 56% accuracy values for the Euclidean distance and RBF kernel techniques, respectively. Thus, the quantum kernel-based technique performs better than the classical techniques. Specifically, the K-medoids with the Pauli expansion circuit generated more accurate results than those generated by the K-medoids with the Euclidean distance and the K-medoids with the RBF kernel.

In QML, quantum computations executed on a quantum computer are typically followed by employing a classical classifier. For example, a feature map can be employed to transform data from one classical distribution to another classical distribution after which, a Support Vector Machine (SVM), Random Forest, XGBoost, or another machine learning classifier can be employed to classify data. Although classical techniques can be employed to generate new data by oversampling or under sampling, it is desirable to employ quantum computing techniques to generate the new data if the subsequent data classification is to be performed by a quantum classifier, to avoid a mismatch in the data processing techniques due to the fundamental differences between classical processing and quantum processing.

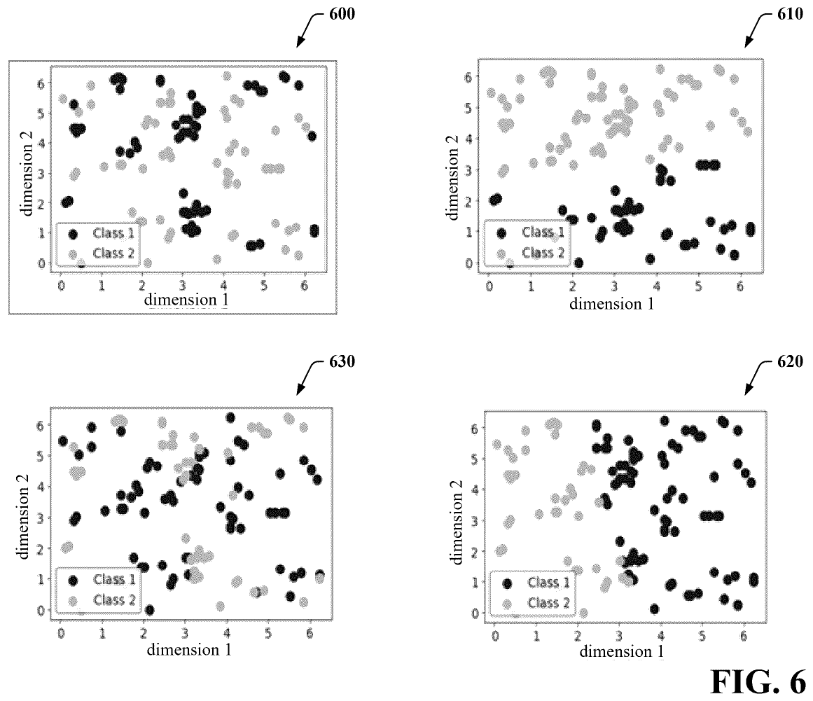

FIG. 6 illustrates example, non-limiting graphs 600, 610, 620 and 630 showing experimental data clustering results in accordance with one or more embodiments described herein. Repetitive description of like elements and/or processes employed in respective embodiments is omitted for sake of brevity.

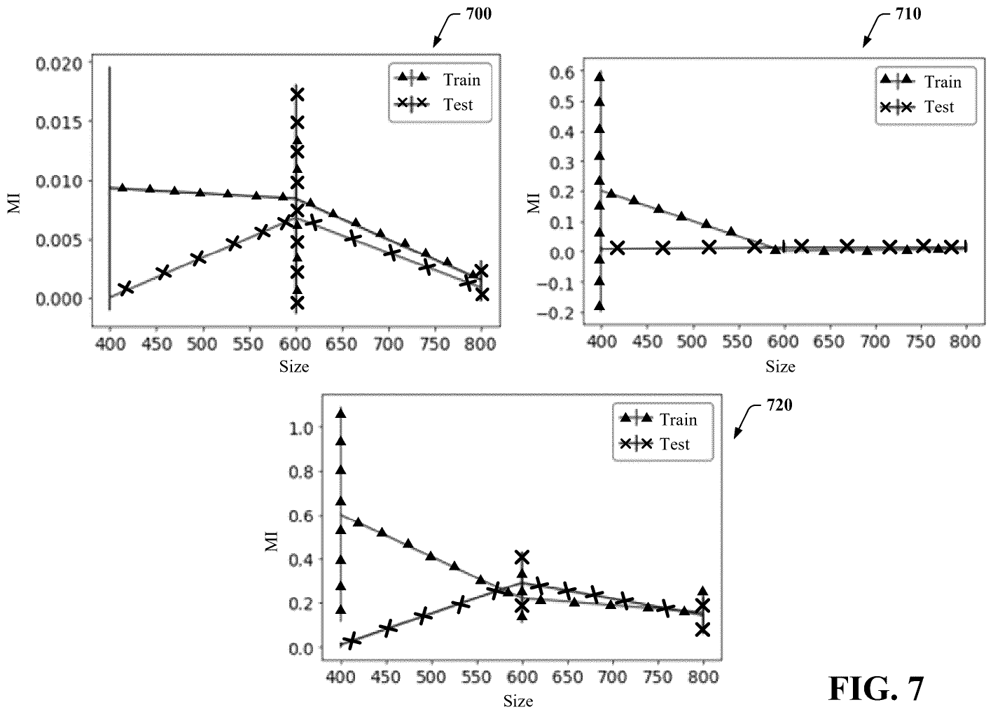

The experimental results shown in FIG. 6 correspond to the clustering techniques and the experimental results described with reference to non-limiting table 500 of FIG. 5. The experimental results shown in FIG. 6 were generated for ad hoc data (Δ=0.5) with 625 data points (N=625). For a clustering technique, the data distribution can be determined by the accuracy of the clustering. Non-limiting graph 600 shows ground truth data, whereas non-limiting graphs 610, 620 and 630 show respective clustered datasets generated by the K-medoids with Euclidean distance, K-medoids with RBF kernel, and K-medoids with the Pauli expansion circuit based on the ground truth data. As seen from non-limiting graph 610 and 620, applying the K-medoids technique on data distributions generated with the Euclidean distance or the RBF kernel techniques can generate a clustering wherein data points from different classes in the ground truth data can become divided in half. On the contrary, applying the K-medoids technique on a data distribution generated with a Pauli expansion circuit-based ZZ feature map can generate a different and more balanced clustering of data with a mixture of data points, as opposed to the ground truth data becoming divided into two halves. As seen from FIG. 7, the clustering generated by the K-medoids with Pauli expansion circuit can also result in better data classification.

FIG. 7 illustrates example, non-limiting graphs 700, 710 and 720 showing experimental training and test results in accordance with one or more embodiments described herein. Repetitive description of like elements and/or processes employed in respective embodiments is omitted for sake of brevity.

With continued reference to FIGS. 5 and 6, non-limiting graphs 700, 710 and 720 respectively correspond to the K-medoids with Euclidean distance, K-medoids with RBF kernels, and K-medoids with Pauli expansion circuit techniques. In each graph in FIG. 7, the Y-axis corresponds to the mutual information values and the X-axis corresponds to the size of the dataset considered. To generate non-limiting graphs 700, 710 and 720, respective machine learning models were trained on the ground truth data shown by non-limiting graph 600, and the trained machine learning models were employed to generate the training and test curves shown. The learning curves shown in FIG. 7 describe the conversions based on different metrics with respect to the number of data points. Evidently, in each scenario, the calculations converge at about 800 for each technique for the datasets employed in the experiment, despite the large error bars.

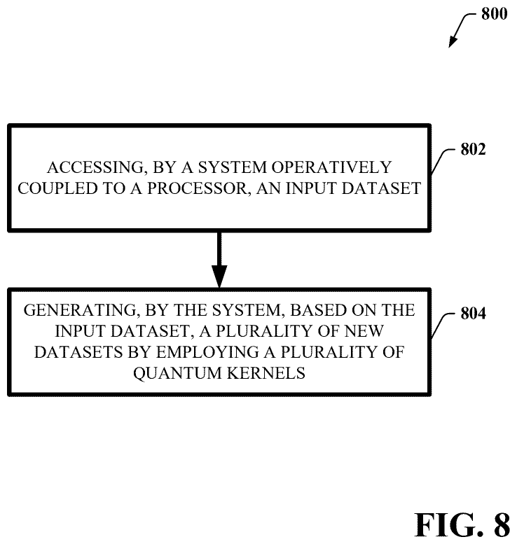

FIG. 8 illustrates a flow diagram of an example, non-limiting method 800 that can employ quantum kernels to generate new data in accordance with one or more embodiments described herein. Repetitive description of like elements and/or processes employed in respective embodiments is omitted for sake of brevity.

At 802, non-limiting method 800 can comprise accessing (e.g., by access component 202), by a system operatively coupled to a processor, an input dataset.

At 804, non-limiting method 800 can comprise generating (e.g., by data generation component 206), by the system, based on the input dataset, a plurality of new datasets by employing a plurality of quantum kernels.

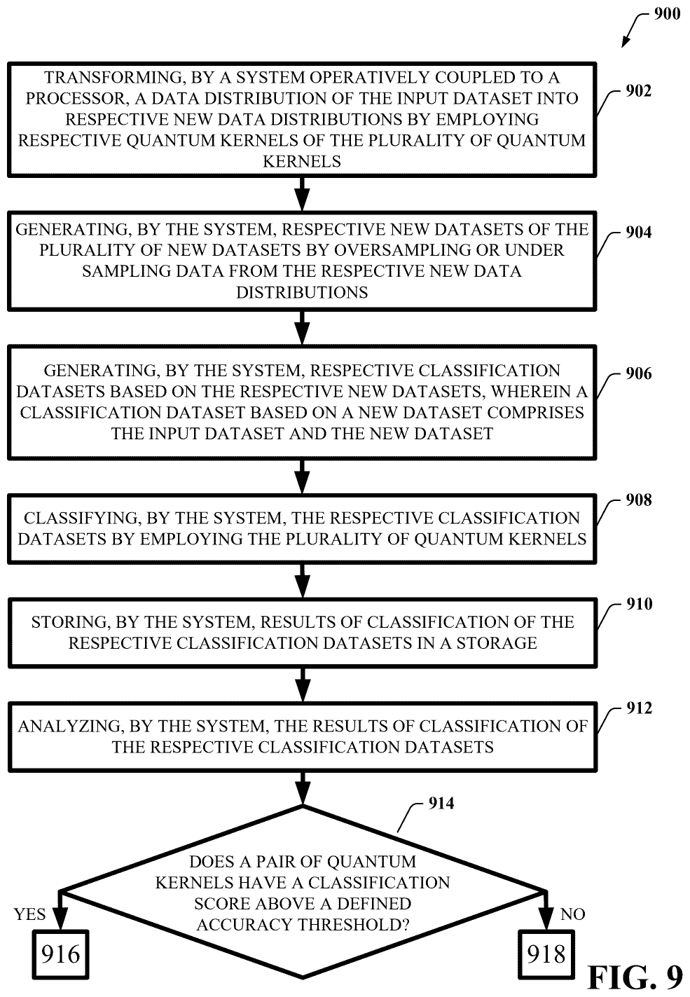

FIG. 9 illustrates a flow diagram of an example, non-limiting method 900 that can be employed to select a pair of quantum kernels to perform data generation and classification in accordance with one or more embodiments described herein. Repetitive description of like elements and/or processes employed in respective embodiments is omitted for sake of brevity.

Steps 902-906 of non-limiting method 900 expand upon step 804 of non-limiting method 800, wherein a system operatively coupled to a processor can generate, based on an input dataset, a version of the input dataset that is over or under balanced by employing a plurality of quantum kernels. The plurality of new datasets can comprise synthetic data generated from the input dataset.

At 902, non-limiting method 900 can comprise transforming (e.g., by data generation component 206), by the system, a data distribution of the input dataset into respective new data distributions by employing respective quantum kernels of the plurality of quantum kernels.

At 904, non-limiting method 900 can comprise generating (e.g., by data generation component 206), by the system, respective new datasets of the plurality of new datasets by oversampling or under sampling data from the respective new data distributions.

At 906, non-limiting method 900 can comprise generating (e.g., by data generation component 206), by the system, respective classification datasets based on the respective new datasets, wherein a classification dataset based on a new dataset comprises the input dataset and the new dataset.

At 908, non-limiting method 900 can comprise classifying (e.g., by data classification component 208), by the system, the respective classification datasets by employing the plurality of quantum kernels.

At 910, non-limiting method 900 can comprise storing (e.g., by storage component 210), by the system, results of classification of the respective classification datasets in a storage.

At 912, non-limiting method 900 can comprise analyzing (e.g., by analysis component 212), by the system, the results of classification of the respective classification datasets.

At 914, non-limiting method 900 can comprise determining (e.g., by quantum kernel identification component 214), by the system, whether a pair of quantum kernels has a classification score above a defined accuracy threshold. If yes, then at 916, non-limiting method 900 can comprise selecting (e.g., by quantum kernel identification component 214), by the system, the pair of quantum kernels to perform data classification on a new input dataset. If not, then at 918, non-limiting method 900 can comprise selecting (e.g., by quantum kernel identification component 214), by the system, a different pair of quantum kernels (i.e., having a classification score above a defined accuracy threshold) to perform data classification on a new input dataset.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as quantum kernel-based data classification code 1026. In addition to block 1026, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1026, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1026 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1026 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Python, R, Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an access component that accesses an input dataset; and
a data generation component that generates, based on the input dataset, a plurality of new datasets by employing a plurality of quantum kernels.

2. The system of claim 1, wherein the data generation component further:
transforms a data distribution of the input dataset into respective new data distributions by employing respective quantum kernels of the plurality of quantum kernels;
generates respective new datasets of the plurality of new datasets by oversampling or under sampling data from the respective new data distributions; and
generates respective classification datasets based on the respective new datasets, wherein a classification dataset based on a new dataset comprises the input dataset and the new dataset.

3. The system of claim 1, further comprising:
a quantum kernel selection component that randomly selects a quantum kernel from the plurality of quantum kernels, wherein the quantum kernel is employed to generate a new dataset of the plurality of new datasets.

4. The system of claim 2, further comprising:
a data classification component that classifies the respective classification datasets by employing the plurality of quantum kernels.

5. The system of claim 4, further comprising:
a storage component that stores results of classification of the respective classification datasets in a storage.

6. The system of claim 5, further comprising:
an analysis component that:
analyzes the results; and
generates, based on analysis of the results, classification scores corresponding to quantum kernels comprised in the plurality of quantum kernels.

7. The system of claim 6, further comprising:
a quantum kernel identification component that:
selects a quantum kernel from a set of the plurality of quantum kernels in an outer loop to be used for data generation for oversampling of minority class or data clustering for under sampling of majority class;
uses the same set of quantum kernels in the inner loop, chooses one of the same set of quantum kernels and with the chosen quantum kernel, classifies the original dataset and stores a result of the classification;
keeps choosing one quantum kernel after another quantum kernel in the inner loop, and classifying and storing the result until the inner loop quantum kernels are exhausted, then selecting the next quantum kernel in the outer loop and performing balancing;
until the quantum kernels in the outer loop are exhausted, iteratively selects a next quantum kernel in the outer loop and perform classification until the inner loop is exhausted; and
once the quantum kernels in the outer loop are exhausted, selects the best result and choose that pair of quantum kernels which produced this best result, wherein the pair comprises a selected quantum kernel in the outer loop for balancing and a selected quantum kernel in the inner loop for classifying, and wherein the best result is defined as the result with the highest area under the curve score.

8. The system of claim 1, wherein the plurality of quantum kernels are quantum feature maps.

9. A computer-implemented method, comprising:
accessing, by a system operatively coupled to a processor, an input dataset; and
generating, by the system, based on the input dataset, a plurality of new datasets by employing a plurality of quantum kernels.

10. The computer-implemented method of claim 9, further comprising:
transforming, by the system, a data distribution of the input dataset into respective new data distributions by employing respective quantum kernels of the plurality of quantum kernels;
generating, by the system, respective new datasets of the plurality of new datasets by oversampling or under sampling data from the respective new data distributions; and
generating, by the system, respective classification datasets based on the respective new datasets, wherein a classification dataset based on a new dataset comprises the input dataset and the new dataset.

11. The computer-implemented method of claim 9, further comprising:
selecting, by the system, a quantum kernel from the plurality of quantum kernels, wherein the quantum kernel is employed to generate a new dataset of the plurality of new datasets, and wherein the quantum kernel is randomly selected.

12. The computer-implemented method of claim 10, further comprising:
classifying, by the system, the respective classification datasets by employing the plurality of quantum kernels.

13. The computer-implemented method of claim 12, further comprising:
storing, by the system, results of classification of the respective classification datasets in a storage.

14. The computer-implemented method of claim 13, further comprising:
analyzing, by the system, the results; and
generating, by the system, based on analysis of the results, classification scores corresponding to quantum kernels comprised in the plurality of quantum kernels.

15. The computer-implemented method of claim 14, further comprising:
selecting, by the system, based on the classification scores, a first quantum kernel, wherein the first quantum kernel is employable to generate a new dataset based on the original dataset through balancing; and
selecting, by the system, based on the classification scores, a second quantum kernel, wherein the second quantum kernel is employable to classify data comprised in the new dataset.

16. The computer-implemented method of claim 9, wherein the plurality of quantum kernels are quantum feature maps.

17. A computer program product for quantum kernel selection, the computer program product comprising a computer readable storage medium having program instructions embodied therewith, the program instructions executable by a processor to cause the processor to:
access, by the processor, an input dataset; and
generate, by the processor, based on the input dataset, a plurality of new datasets by employing a plurality of quantum kernels.

18. The computer program product of claim 17, wherein the program instructions are further executable by the processor to cause the processor to:
transform, by the processor, a data distribution of the input dataset into respective new data distributions by employing respective quantum kernels of the plurality of quantum kernels;
generate, by the processor, respective new datasets of the plurality of new datasets by oversampling or under sampling data from the respective new data distributions; and
generate, by the processor, respective classification datasets based on the respective new datasets, wherein a classification dataset based on a new dataset comprises the input dataset and the new dataset.

19. The computer program product of claim 18, wherein the program instructions are further executable by the processor to cause the processor to:
classify, by the processor, the respective classification datasets by employing the plurality of quantum kernels.

20. The computer program product of claim 17, wherein the plurality of quantum kernels are quantum feature maps.
